(19) United States
(12) Patent Application Publication
(10) Pub. No.: US 2021/0005369 A1
(43) Pub. Date: Jan. 7, 2021

(54) SOLENOID

(71) Applicant: DENSO CORPORATION, Kariya-city (JP)

(72) Inventors: Koutarou KASHIWA, Kariya-city (JP); Kazuhiro SASAO, Kariya-city (JP); Motoyoshi ANDOH, Kariya-city (JP)

(21) Appl. No.: 16/918,166

(22) Filed: Jul. 1, 2020

(30) Foreign Application Priority Data
Jul. 2, 2019 (JP) 2019-123302

(51) Int. Cl. H01F 7/08; H01F 7/16

(52) U.S. Cl. CPC H01F 7/081; F16K 31/0613; H01F 7/16

(57) ABSTRACT

A solenoid has a coil, a yoke including a side surface portion along an axial direction and a bottom portion, a columnar plunger configured to slide in an axial direction, a stator core, and a second magnetic flux transfer portion. The stator core includes a magnetic attraction core configured to attract magnetically the plunger by a magnetic force generated by a coil, and a sliding core having a cylindrical core portion, a first magnetic flux transfer portion, and a magnetic flux passage suppressing portion configured to suppress passage of magnetic flux between the sliding core and the magnetic attraction core. The second magnetic flux transfer portion transfers the magnetic flux between the magnetic attraction core and the side surface portion. A first breathing groove extending in the axial direction in communication with the outside is formed on an inner peripheral surface of the yoke.

### CROSS REFERENCE TO RELATED APPLICATION

The present application is based on Japanese Patent Application No. 2019-123302 filed on Jul. 2, 2019, disclosure of which are incorporated herein by reference.

### TECHNICAL FIELD

The present disclosure relates to a solenoid.

### BACKGROUND

Conventionally, a solenoid has a coil that generates a magnetic force when energized, a stator core provided inside the coil, and a plunger that slides inside the stator core.

### SUMMARY

An object of the present disclosure is to provide a solenoid that suppresses an increase in the size of the solenoid while securing a breathing passage.

The present disclosure can be realized as the following embodiments.

According to one embodiment of the present disclosure, a solenoid is provided. The solenoid includes a coil that generates a magnetic force when energized, a yoke including a side surface portion along an axial direction and a bottom portion formed along a direction intersecting the axial direction, and the yoke being configured to accommodate the coil, a columnar plunger configured to slide in the axial direction. A stator core includes a magnetic attraction core arranged in the axial direction to face a distal end surface of the plunger and configured to attract magnetically the plunger by a magnetic force generated by the coil, a sliding core having a cylindrical core portion that is disposed inside the coil in a radial direction perpendicular to the axial direction and accommodates the plunger, and a first magnetic flux transfer portion that is formed from a core end portion, which is an end of the core portion in the axial direction and faces the bottom portion, toward an outside in the radial direction, and is configured to transfer the magnetic flux between the yoke and the core portion, a magnetic flux passage suppressing portion configured to suppress passage of magnetic flux between the sliding core and the magnetic attraction core. A second magnetic flux transfer portion that is disposed radially outside a magnetic attraction core end, which is an end in the axial direction of the magnetic attraction core and is opposite to a side facing the distal end surface, and is configured to transfer the magnetic flux between the magnetic attraction core and the side surface portion. A first breathing groove extending in the axial direction in communication with the outside is formed on an inner peripheral surface of the yoke.

The present disclosure can be realized as the following embodiments. For example, the present disclosure can be realized in the embodiment of a solenoid valve, a method of manufacturing a solenoid, and the like.

### BRIEF DESCRIPTION OF DRAWINGS

FIG. 1 is a sectional view showing a schematic configuration of a linear solenoid valve to which a solenoid according to a first embodiment is applied;

FIG. 2 is a sectional view showing a detailed configuration of a solenoid;

FIG. 3 is a sectional view taken along a line III-III in FIG. 2;

FIG. 4 is a sectional view of a linear solenoid valve to which a solenoid according to a second embodiment is applied;

FIG. 5 is a sectional view and a perspective view of a linear solenoid valve to which the solenoid according to the second embodiment is applied;

FIG. 6 is a sectional view of a linear solenoid valve to which a solenoid according to a third embodiment is applied;

FIG. 7 is a sectional view showing a detailed configuration of a solenoid according to a fourth embodiment;

FIG. 8 is a sectional view showing a detailed configuration of a solenoid according to a fifth embodiment;

FIG. 9 is a sectional view showing a detailed configuration of a solenoid according to a sixth embodiment;

FIG. 10 is a sectional view of a linear solenoid valve to which a solenoid according to another embodiment is applied;

FIG. 11 is a sectional view of a linear solenoid valve to which a solenoid according to another embodiment is applied;

FIG. 12 is a sectional view of a linear solenoid valve to which a solenoid according to another embodiment is applied; and

FIG. 13 is a sectional view of a linear solenoid valve to which a solenoid according to another embodiment is applied.

### DETAILED DESCRIPTION

### A. First Embodiment

### A-1. Constitution

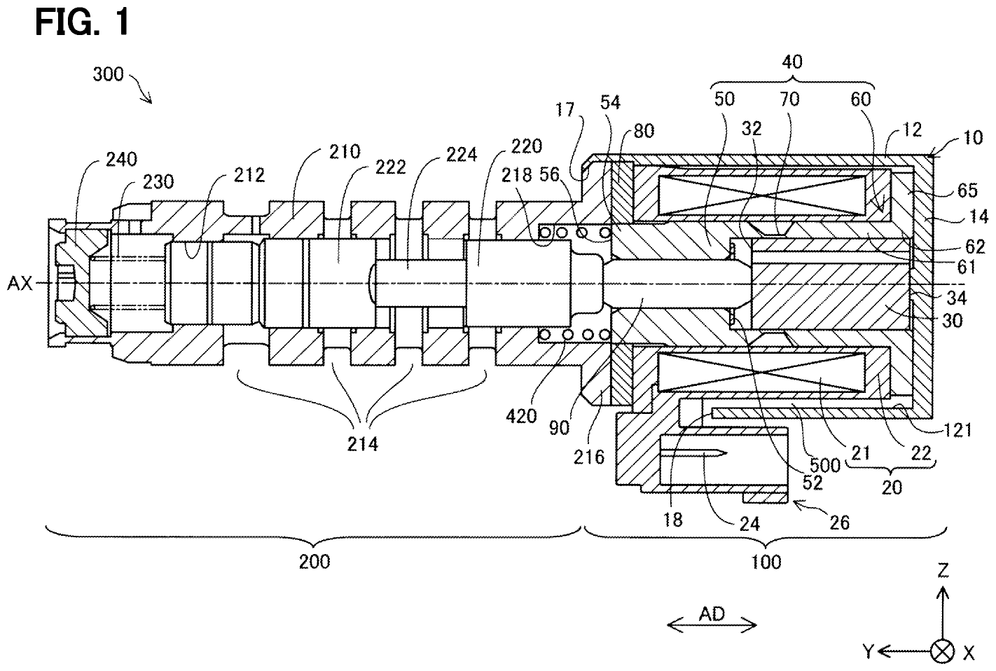

A solenoid 100 according to the first embodiment shown in FIG. 1 is applied to a linear solenoid valve 300 and functions as an actuator for driving a spool valve 200. The linear solenoid valve 300 is configured to control a hydraulic pressure of hydraulic oil supplied to a vehicle automatic transmission (not shown), and is mounted on a valve body provided on an outer surface of a transmission case (not shown). FIG. 1 schematically shows a cross section of the linear solenoid valve 300 taken along a central axis AX.

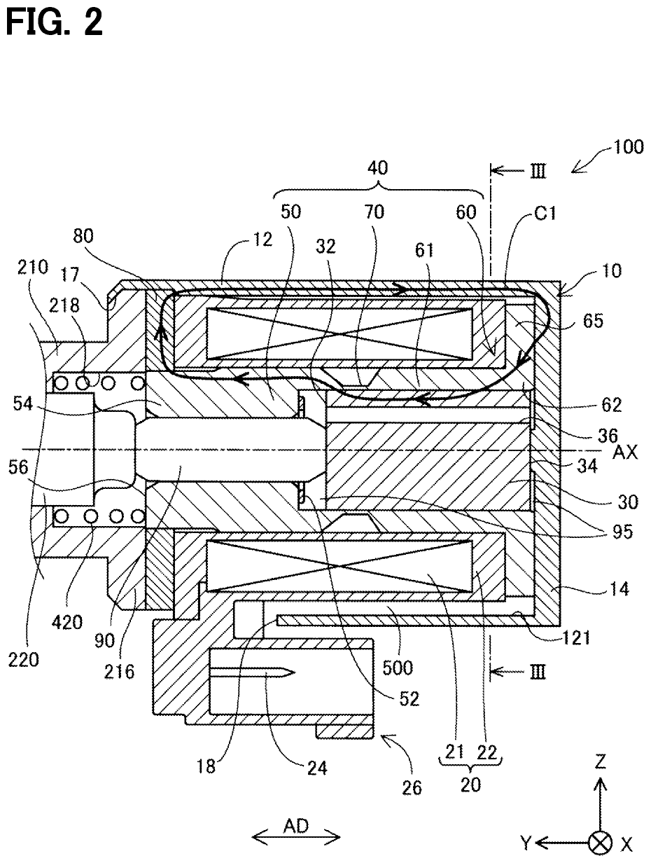

The linear solenoid valve 300 includes a spool valve 200 and a solenoid 100 arranged side by side along the central axis AX. FIGS. 1 and 2 show the solenoid 100 and the linear solenoid valve 300 in a non-energized state. Although the linear solenoid valve 300 of the present embodiment is a normally closed type, it may be a normally open type.

The spool valve 200 shown in FIG. 1 adjusts an opening area of a plurality of oil ports 214 described later. The spool valve 200 includes a sleeve 210, a spool 220, a spring 230, and a spring load adjusting member 240.

The sleeve 210 has a substantially cylindrical external shape. The sleeve 210 is formed with an insertion hole 212 penetrating along the central axis AX and a plurality of oil ports 214 communicating with the insertion hole 212 and opening in a radial direction. The spool 220 is inserted into the insertion hole 212. An end of the insertion hole 212 on the solenoid 100 side is formed to have an enlarged diameter and functions as an elastic member accommodating portion 218. An elastic member 420 described later is accommodated in the elastic member accommodating portion 218. The plurality of oil ports 214 are formed side by side along a direction parallel to the central axis AX. The direction is hereinafter, referred to as “axial direction AD”. The plurality of oil ports 214 function as, for example, an input port, an output port, a feedback port, a drain port, and the like. The input port communicates with an oil pump (not shown) to receive a hydraulic pressure. The output port communicates with a clutch piston (not shown) to supply a hydraulic pressure. The feedback port applies a load to the spool 220 based on the output hydraulic pressure. The drain port discharges the hydraulic oil. A flange 216 is formed at an end of the sleeve 210 on the solenoid 100 side. The flange 216 has a diameter that increases radially outward, and is fixed to a yoke 10 of the solenoid 100 described later.

The spool 220 has a plurality of large-diameter portions 222 and small-diameter portion 224 arranged side by side along the axial direction AD, and has a substantially rod-like external shape. The spool 220 slides along the axial direction AD inside the insertion hole 212, and adjusts the opening area of the plurality of oil ports 214 according to a position along the axial direction AD between the large-diameter portion 222 and the small-diameter portion 224. A shaft 90 is disposed in contact with one end of the spool 220, and transmits a driving force of the solenoid 100 to the spool 220. The spring 230 is arranged at the other end of the spool 220. The spring 230 is configured by a compression coil spring, and presses the spool 220 in the axial direction AD to urge the spool 220 toward the solenoid 100. The spring load adjusting member 240 is arranged in contact with the spring 230, and adjusts the spring load of the spring 230 by adjusting an amount of screwing into the sleeve 210.

The solenoid 100 shown in FIGS. 1 and 2 is energized by an electronic control unit (not shown) to drive the spool valve 200. The solenoid 100 includes a yoke 10, a coil 20, a plunger 30, a stator core 40, a second magnetic flux transfer portion 80, and the elastic member 420.

The yoke 10 is made of a magnetic metal, and forms an outer shell of the solenoid 100 as shown in FIG. 2. The yoke 10 has a bottomed cylindrical external shape, and accommodates the coil 20, the plunger 30, and the stator core 40. The yoke 10 has a side surface portion 12, a bottom portion 14, an opening 17, and a notch 18.

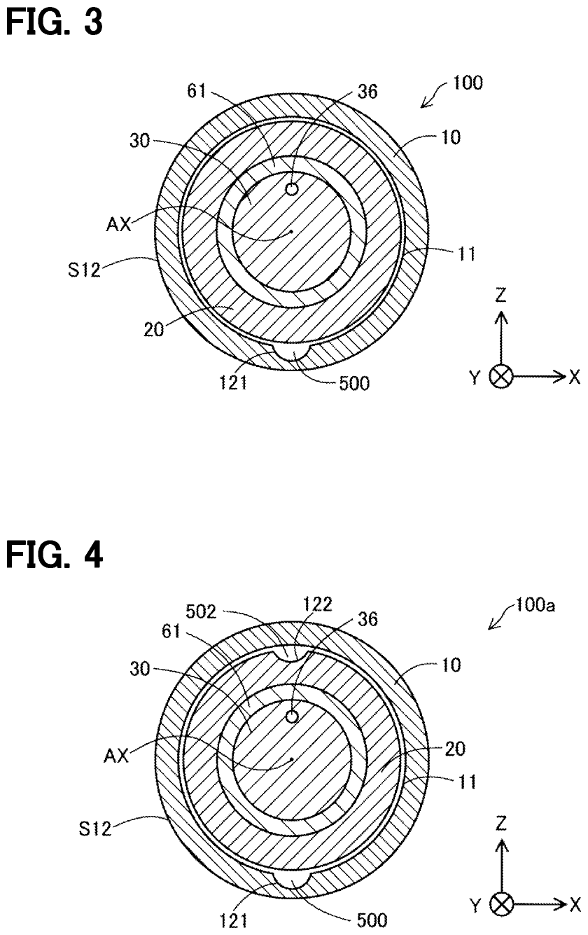

The side surface portion 12 has a substantially cylindrical external shape along the axial direction AD, and is disposed radially outside the coil 20. As shown in FIGS. 1 to 3, a first breathing groove 121 is formed on an inner peripheral surface 11 of the side surface portion 12. The first breathing groove 121 extends in the axial direction AD as shown in FIGS. 1 and 2, when the radial direction is the depth direction as shown in FIG. 3. The first breathing groove 121 allows a fluid such as hydraulic oil existing in the environment in which the solenoid 100 is mounted to flow. As shown in FIGS. 1 to 3, a space is formed in the axial direction AD between the first breathing groove 121 and the outer peripheral surface of the coil 20, and is used as the breathing passage 500. The breathing passage 500 plays role of an oil passage, and the oil passage communicates with a space between an outer peripheral surface of a first magnetic flux transfer portion 65 and an inner peripheral surface of the side surface portion 12, and a space between an outer peripheral surface of the first magnetic flux transfer portion 65 from a base of a connector 26 and an inner peripheral surface of the side surface portion 12. In the present embodiment, a width of the first breathing groove 121 in the X-axis direction is about 5 mm (millimeter). The width is not limited to 5 mm and may be any size.

The bottom portion 14 is formed at the end of the side surface portion 12 and perpendicular to the axial direction AD at the end of the side surface portion 12 opposite to the end opposite to the spool valve 200, and closes the end of the side surface portion 12. The bottom portion 14 is not limited to being perpendicular to the axial direction AD, and may be formed substantially perpendicularly, or may be formed to intersect with the axial direction AD according to the shape of a first magnetic flux transfer portion 65 described later. The bottom portion 14 faces a base end surface 34 of the plunger 30 described later. A detailed description of the bottom portion 14 will be described later. In the following description, a space surrounded by the bottom portion 14, the stator core 40, and the shaft 90 is also referred to as a “plunger chamber 95”. The plunger chamber 95 houses the plunger 30.

An opening 17 is formed at an end of the side surface portion 12 on the spool valve 200 side. The opening 17 is caulked and fixed to a flange 216 of the spool valve 200 after the components of the solenoid 100 are assembled inside the yoke 10. The spool valve 200 and the yoke 10 may be fixed by using an arbitrary method such as welding, instead of fixing by caulking.

The notch 18 is formed by cutting out a part in the circumferential direction of the opening 17. A connector 26 to be described later is exposed from the yoke 10 through the notch 18. In addition, as described later, the notch 18 functions as a port for the fluid flowing into the breathing passage 500.

The coil 20 is disposed radially inside the side surface portion 12 of the yoke 10. The coil 20 generates a magnetic force when energized, and generates a loop-shaped magnetic flux passing through the side surface portion 12 of the yoke 10, the bottom portion 14 of the yoke 10, the stator core 40, the plunger 30, and the second magnetic flux transfer portion 80 (the loop-shaped magnetic flux is hereinafter, referred to as “magnetic circuit”). In the state shown in FIGS. 1 and 2, the energization of the coil 20 is not performed and a magnetic circuit is not formed. For convenience of explanation, a part of the magnetic circuit Cl formed when the energization of the coil 20 is performed is schematically indicated by a thick arrow in FIG. 2.

The coil 20 has a winding part 21 and a bobbin 22. The winding part 21 is formed of a conductive wire coated with an insulating coating. The bobbin 22 is made of a resin. The bobbin 22 is connected to the connector 26 arranged on the outer periphery of the yoke 10. The connector 26 is exposed from the yoke 10 through the notch 18. A connection terminal 24 to which the end of the winding part 21 is connected is arranged inside the connector 26. The connector 26 electrically connects the solenoid 100 to the electronic control device via a connection line (not shown).

As shown in FIG. 3, an outer diameter of the coil 20 is formed slightly smaller than an inner diameter of the side surface portion 12 of the yoke 10. Therefore, in the present embodiment, except for the breathing passage 500, only a small gap is formed between the outer peripheral surface of the coil 20 and the inner peripheral surface 11 of the yoke 10.

As shown in FIG. 2, the plunger 30 is housed in the plunger chamber 95. The plunger 30 has a substantially cylindrical external shape and is made of a magnetic metal. In this embodiment, plating is applied on the outer peripheral surface of the plunger 30. By such plating, the surface hardness of the plunger 30 can be improved. The plunger 30 slides in the axial direction AD on an inner peripheral surface of a core portion 61 of the stator core 40 described later. The above-described shaft 90 is disposed in contact with an end surface of the plunger 30 on the spool valve 200 side (hereinafter, also referred to as a “distal end surface 32”). Thereby, the plunger 30 is urged toward the bottom portion 14 side of the yoke 10 along the axial direction AD by the urging force of the spring 230 transmitted to the spool 220 shown in FIG. 1. As shown in FIG. 2, an end surface of the plunger 30 opposite to the distal end surface 32 (hereinafter, also referred to as a “base end surface 34”) faces the bottom portion 14 of the yoke 10. Inside the plunger 30, a breathing hole 36 penetrating in the axial direction AD is formed. The breathing hole 36 allows the fluid located on the base end surface 34 side and the distal end surface 32 side of the plunger 30 to flow in the plunger chamber 95.

The Stator core 40 is made of a magnetic metal, and is disposed between the coil 20 and the plunger 30. The stator core 40 is configured by a member in which a magnetic attraction core 50, a sliding core 60, and a magnetic flux passage suppressing portion 70 are integrated.

The magnetic attraction core 50 is disposed so as to surround the shaft 90 in the circumferential direction. The magnetic attraction core 50 constitutes a portion of the stator core 40 on the spool valve 200 side, and magnetically attracts the plunger 30 by the magnetic force generated by the coil 20. A stopper 52 is disposed on a surface of the magnetic attraction core 50 facing the distal end surface 32 of the plunger 30. The stopper 52 is made of a non-magnetic material, and prevents a direct contact between the plunger 30 and the magnetic attraction core 50, and also prevents the plunger 30 from being separated from the magnetic attraction core 50 due to the magnetic attraction.

The sliding core 60 constitutes a portion of the stator core 40 on the bottom portion 14 side, and is disposed radially outside the plunger 30. The sliding core 60 has a core portion 61 and a first magnetic flux transfer portion 65.

The core portion 61 has a substantially cylindrical external shape, and is disposed between the coil 20 and the plunger 30 in the radial direction orthogonal to the axial direction AD. The core portion 61 guides the movement of the plunger 30 along the axial direction AD. As a result, the plunger 30 slides directly on an inner peripheral surface of the core portion 61. An end portion of the sliding core 60 that is located on an opposite side to the magnetic attraction core 50 side (hereinafter, also referred to as a “core end portion 62”) is in contact with the bottom portion 14.

The first magnetic flux transfer portion 65 is formed radially outward from the core end portion 62 over the entire circumference of the core end portion 62. For this reason, the first magnetic flux transfer portion 65 is located between the bobbin 22 and the bottom portion 14 of the yoke 10 in the axial direction AD. The first magnetic flux transfer portion 65 transfers magnetic flux between the yoke 10 and the plunger 30 via the core portion 61. The first magnetic flux transfer portion 65 of the present embodiment transfers magnetic flux between the bottom portion 14 of the yoke 10 and the plunger 30. The first magnetic flux transfer portion 65 may transfer magnetic flux between the side surface portion 12 of the yoke 10 and the plunger 30. Further, the first magnetic flux transfer portion 65 of the present embodiment is formed integrally with the core portion 61. The first magnetic flux transfer portion 65 and the core portion 61 may be integrated after being formed as separate members. For example, the core portion 61 may be press-fitted into a through hole of the first magnetic flux transfer portion 65 formed in a ring shape, or may be fixed by welding or the like after the core portion 61 is inserted into the through hole. On the end surface of the first magnetic flux transfer portion 65 facing the bottom portion 14, a radial groove is formed along the radial direction so as to communicate a radial inside and a radial outside of the first magnetic flux transfer portion 65. In the present embodiment, an end on the radial outside of the radial groove overlaps with the arrangement position of the connector 26 in the circumferential direction. The end communicates with a space between the outer peripheral surface of the first magnetic flux transfer portion 65 and the inner peripheral surface of the side surface portion 12. The space communicates with an end of the breathing passage 500 in the axial direction AD. On the other hand, an end on radial inside of the radial groove communicates with the plunger chamber 95. Therefore, the plunger chamber 95 communicates with the outside through a passage formed as a gap between the radial groove and the bottom portion 14, a space between the outer peripheral surface of the first magnetic flux transfer portion 65 and the inner peripheral surface of the side surface portion 12, and the breathing passage 500. With such a configuration, a change in pressure in the plunger chamber 95 due to the movement of the plunger 30 in the axial direction AD can be suppressed, and a decrease in the slidability of the plunger 30 can be suppressed.

The magnetic flux passage suppressing portion 70 is formed between the magnetic attraction core 50 and the core portion 61 in the axial direction AD. The magnetic flux passage suppressing portion 70 suppresses the direct passage of magnetic flux between the core portion 61 and the magnetic attraction core 50. The magnetic flux passage suppressing portion 70 of the present embodiment is configured such that a radial thickness of the stator core 40 is formed to be thin, so that the magnetic resistance of the magnetic flux passage suppressing portion 70 is higher than that of the magnetic attraction core 50 and the core portion 61.

The second magnetic flux transfer portion 80 is disposed between the coil 20 and the flange 216 of the spool valve 200 in the axial direction AD. In other words, the second magnetic flux transfer portion 80 is disposed radially outward of an end of the magnetic attraction core 50 of the stator core 40 (described later) in the axial direction AD, and an end of the magnetic attraction core opposite to the plunger 30 side. The end is hereinafter also referred to as “magnetic attraction core end 54”. The second magnetic flux transfer portion 80 has a ring-like external shape and is made of a magnetic metal. The second magnetic flux transfer portion 80 transfers a magnetic flux between the magnetic attraction core 50 of the stator core 40 and the side surface portion 12 of the yoke 10. The second magnetic flux transfer portion 80 is configured to be displaceable in the radial direction. As a result, variations in the dimensions of the stator core 40 during manufacture and imperfect alignment of the stator core 40 during assembly are absorbed. In the present embodiment, the magnetic attraction core 50 described later is press-fitted into the second magnetic flux transfer portion 80. The magnetic attraction core 50 may be fitted to the second magnetic flux transfer portion 80 with a slight radial gap instead of the press-fitting.

The elastic member 420 is accommodated in an elastic member accommodating portion 218 formed in the sleeve 210 of the spool valve 200 and urges the stator core 40 toward the bottom portion 14. The elastic member 420 is disposed in contact with an end surface (hereinafter, also referred to as the “end surface 56”) of the magnetic attraction core 50 in the axial direction AD and opposite to the plunger 30 side. In the present embodiment, the elastic member 420 is configured by a compression coil spring having a substantially cylindrical external shape. The spool 220 is inserted radially inside the elastic member 420. Since the stator core 40 is urged in the axial direction AD toward the bottom portion 14 of the yoke 10 by the elastic member 420, the first magnetic flux transfer portion 65 is pressed against the bottom portion 14, and the first magnetic flux transfer portion 65 is pressed to the bottom portion 14. Therefore, the loss of the magnetic flux transmitted from the bottom portion 14 of the yoke 10 to the first magnetic flux transfer portion 65 is suppressed.

When power is supplied to the winding part 21, a magnetic circuit Cl is formed inside the solenoid 100. Although different from a state shown in FIGS. 1 and 2, the plunger 30 is drawn toward the magnetic attraction core 50 by the formation of the magnetic circuit Cl and slides on the inner peripheral surface of the core portion 61 in the axial direction AD. As the current flowing through the coil 20 increases, the magnetic flux density of the magnetic circuit Cl increases, and the stroke amount of the plunger 30 increases.

When the plunger 30 moves toward the magnetic attraction core 50, the shaft 90 abutting on the distal end surface 32 of the plunger 30 presses the spool 220 shown in FIG. 1 toward the spring 230. As a result, the opening area of the oil port 214 is adjusted, and a hydraulic pressure proportional to the value of the current flowing through the winding part 21 is output.

According to the solenoid 100 of the first embodiment described above, the first breathing groove 121 extending in the axial direction in communication with the outside is formed on the inner peripheral surface 11 of the yoke. Therefore, a gap between the first breathing groove 121 and the outer peripheral surface of the coil can be used as the breathing passage 500. Therefore, the size of the gap (the length in the radial direction) is smaller and an outer diameter of the yoke can be reduced in comparison with a configuration in which only the gap formed over the entire circumference between the outer peripheral surface of the coil and the inner peripheral surface of the yoke is used as a breathing passage. As described above, according to the solenoid of the present embodiment, it is possible to suppress an increase in size of the solenoid while securing the breathing passage.

### B. Second Embodiment

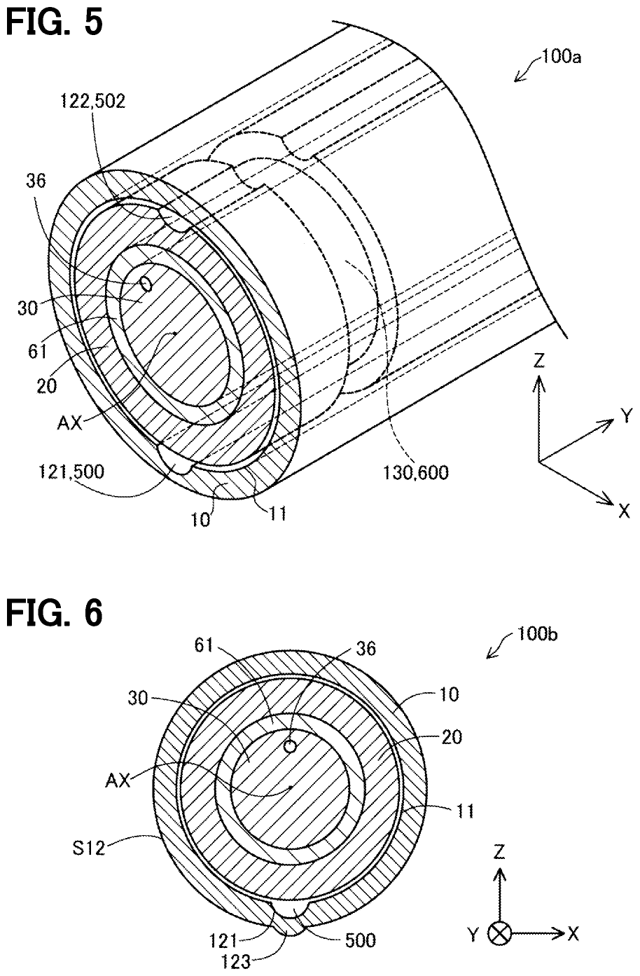

As shown in FIG. 4, a solenoid 100a of the second embodiment has a second breathing groove 122 formed on the outer peripheral surface of the coil 20. As shown in FIG. 5, a circumferential groove 130 is formed on the outer peripheral surface of the coil 20 along the circumferential direction and connects the first breathing groove 121 and the second breathing groove 122. A configuration of groove is different from the solenoid 100 of the first embodiment. The configuration of the solenoid 100a according to the second embodiment other than the above is the same as the configuration of the solenoid 100 according to the first embodiment. Therefore, the same components are denoted by the same reference numerals, and description thereof will be omitted.

As shown in FIG. 4, the second breathing groove 122 is formed on the outer peripheral surface of the coil 20. The second breathing groove 122 is formed at a position in the +Z direction from the position of the first breathing groove 121. That is, the first breathing groove 121 and the second breathing groove 122 have a positional relationship of being shifted by 180 degrees with respect to the center axis AX. A space formed in the axial direction AD between the second breathing groove 122 and the inner peripheral surface 11 of the yoke 10 is used as a breathing passage 502. The breathing passage 502 plays a role of an oil passage similarly to the breathing passage 500. In the solenoid 100a, since two breathing passages 500 and 502 are formed between the yoke 10 and the coil 20, it is possible to increase the amount of breathing. Therefore, in the present embodiment, except for the breathing passage 500 and the breathing passage 502, only a small gap is formed between the outer peripheral surface of the coil 20 and the inner peripheral surface 11 of the yoke 10.

As shown in FIG. 5, the circumferential groove 130 is formed on the outer peripheral surface of the coil 20 along the circumferential direction. The circumferential groove 130 is formed more apart in the +Y direction than a position in cross-section shown in FIGS. 3 and 4. A circumferential length along the circumferential groove 130 is smaller than a circumferential length of the other portion of the outer circumferential surface of the coil 20 and is larger than a length along the outer circumferential surface of the core portion 61. A space formed by the circumferential groove 130, that is, a space formed by the circumferential groove 130 and the inner peripheral surface 11 of the yoke 10 is used as a breathing passage 600. The breathing passage 600 plays a role of connecting the breathing passage 502 and the breathing passage 500. The breathing passage 600 allows the oil to be bridged between the breathing passage 502 and the outside.

The solenoid 100a according to the second embodiment described above has the same effect as the solenoid 100 according to the first embodiment. In addition, in the solenoid 100a of the second embodiment, the first breathing groove 121 is formed on the inner peripheral surface 11 of the yoke 10, and the second breathing groove 122 is formed on the outer peripheral surface of the coil 20 which is at least one of the inner peripheral surface 11 of the yoke 10 and the outer peripheral surface of the coil 20. Further, on the outer peripheral surface of the coil 20, the circumferential groove 130 is formed along the circumferential direction and connects the first breathing groove 121 and the second breathing groove 122. For this reason, the second breathing groove 122 can be connected to the breathing passage 500 via the circumferential groove 130, and the breathing passage 502 is connected to the outside from the breathing passage 500 via the breathing passage 600. Therefore, the breathing passage 502 becomes breathable with the outside. Therefore, the amount of breathing (the amount of oil flow) in the axial direction AD can be increased. If the amount of oil to be flowed is the same, the size of the gap (the length in the radial direction) is smaller and an outer diameter of the yoke can be reduced in comparison with a configuration in which only the gap formed over the entire circumference between the outer peripheral surface of the coil 20 and the inner peripheral surface 11 of the yoke 10 is used as a breathing passage.

### C. Third Embodiment

As shown in FIG. 6, on the outer peripheral surface S12 of the yoke 10, at a position corresponding to the first breathing groove 121, a protrusion (a protrusion 123 described later) that extends in the axial direction and protrudes in the outer diameter direction is formed. The above configuration differs from the solenoid 100 of the first embodiment. The other configuration of the solenoid 100b according to the third embodiment other than the above is the same as the configuration of the solenoid 100 according to the first embodiment. Therefore, the same components are denoted by the same reference numerals, and description thereof will be omitted.

The protrusion 123 is formed on the outer peripheral surface S12 of the yoke 10 at a position corresponding to the −Z direction with respect to the first breathing groove 121. The first breathing groove 121 and the protrusion 123 are formed at the same position in the circumferential direction, and have substantially the same shape. The protrusion 123 plays a role of increasing the strength of the yoke 10. Specifically, since the protrusion 123 is formed on the outer peripheral surface S12 of the yoke 10, the thickness (radial length) of the portion of the yoke 10 where the first breathing groove 121 is formed can be made almost the same as the other part of the yoke 10. Therefore, in the solenoid 100b of the third embodiment, a decrease in the strength of the yoke 10 due to the first breathing groove 121 is suppressed.

Such a protrusion 123 can be formed by, for example, press working. Specifically, a cylindrical member to be the side portion 12 of the yoke 10 is prepared. Then, the press jig is inserted into the inner hole of the cylindrical member in a state where the first breathing groove 121 and the protrusion 123 are not formed. Thereafter, the pressing jig is pressed against the inner peripheral surface of the cylindrical member so as to apply a load radially outward to the inner peripheral surface. Thereby, the first breathing groove 121 and the protrusion 123 can be simultaneously formed on the cylindrical member.

The solenoid 100b according to the third embodiment described above has the same effect as the solenoid 100 according to the first embodiment. In addition, the protrusion 123 extending in the axial direction and protruding in the outer diameter direction is formed at a position corresponding to the first breathing groove 121 on the outer peripheral surface of the yoke 10. For this reason, since the protrusion 123 is formed on the outer peripheral surface S12 of the yoke 10, the thickness (radial length) of the portion of the yoke 10 where the first breathing groove 121 is formed can be made almost same as the other part of the yoke 10. Therefore, a decrease in the strength of the yoke 10 can be suppressed while reducing the outer diameter of the yoke 10. Further, since the protrusion 123 is formed at a position corresponding to the first breathing groove 121, in the process of forming the first breathing groove 121 and the protrusion 123, both of the first breathing groove 121 and the protrusion 123 can be formed simultaneously by using press working. Therefore, the manufacturing cost and the manufacturing time can be reduced as compared with the configuration in which the first breathing groove 121 and the protrusion 123 are formed by cutting work.

### D. Fourth Embodiment

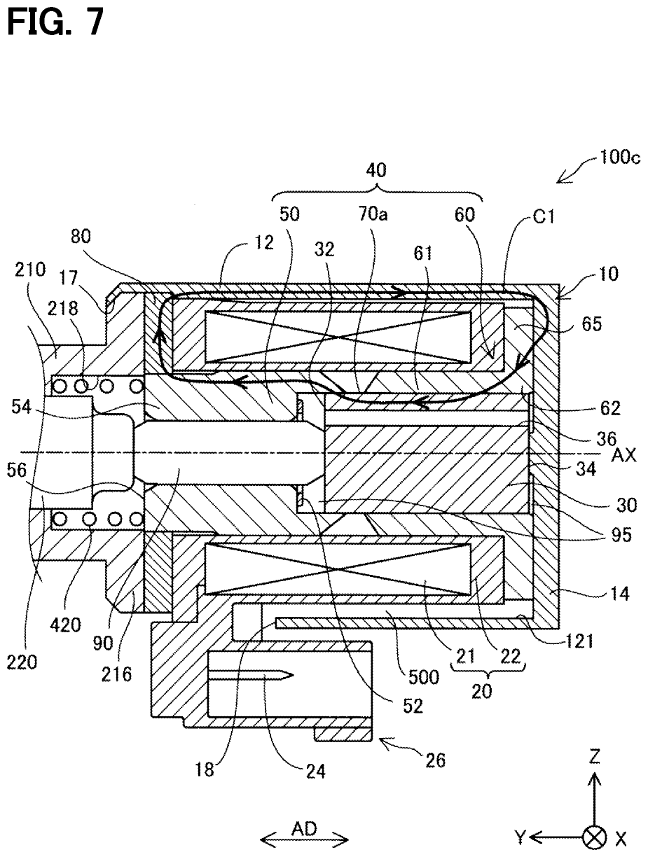

As shown in FIG. 7, the solenoid 100c of the fourth embodiment includes a different magnetic flux passage suppressing portion 70a instead of the magnetic flux passage suppressing portion 70. Thereby, the magnetic attraction core 50 and the core portion 61 are formed separately from each other. The fourth embodiment differs from the solenoid 100 of the first embodiment in this point. The other configuration of the solenoid 100c according to the fourth embodiment other than the above is the same as the configuration of the solenoid 100 according to the first embodiment. Therefore, the same components are denoted by the same reference numerals, and description thereof will be omitted.

In the magnetic flux passage suppressing portion 70 of the solenoid 100 according to the first embodiment, the radial thickness of the stator core 40 is formed to be thin. However, in the magnetic flux passage suppressing portion 70a in the solenoid 100c of the fourth embodiment, all of the thin portions are omitted, that is, the magnetic flux passage suppressing portion 70a is entirely constituted by a space. With such a configuration, the magnetic attraction core 50 and the core portion 61 are separated from each other, and the flow of the magnetic flux directly between the core portion 61 and the magnetic attraction core 50 is further suppressed. Therefore, the magnetic force indicated by the thick arrow in FIG. 7 is guided from the first magnetic flux transfer portion 65 to the plunger 30 side, and the magnetic efficiency is increased, and the slidability of the plunger 30 can be improved.

The solenoid 100c according to the fourth embodiment described above has the same effect as the solenoid 100 according to the first embodiment. In addition, the magnetic attraction core 50 and the core portion 61 are separated from each other, and both of the magnetic attraction core 50 and the core portion 61 are spatially separated in the axial direction AD by the magnetic flux passage suppressing portion 70a. Therefore, the magnetic flux passing through the core portion 61 can be directed to the plunger 30. For this reason, the magnetic force is easily transmitted to the plunger 30, so that the magnetic efficiency is increased and the slidability of the plunger 30 can be improved.

### E. Fifth Embodiment

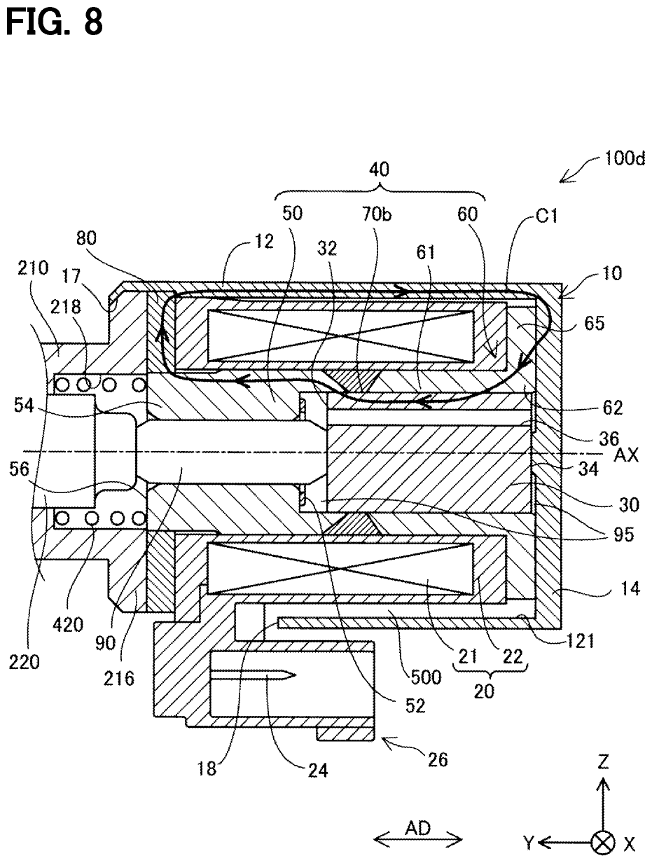

As shown in FIG. 8, the solenoid 100d of the fifth embodiment has a non-magnetic material flux passage suppressing portion 70b formed between the magnetic attraction core 50 and the core portion 61. The fifth embodiment differs from the solenoid 100c of the fourth embodiment in this point. The other configuration of the solenoid 100d according to the fifth embodiment other than the above is the same as the configuration of the solenoid 100c according to the fourth embodiment. Therefore, the same components are denoted by the same reference numerals, and description thereof will be omitted.

As shown in FIG. 8, the magnetic flux passage suppressing portion 70b of the fifth embodiment is a connection portion made of a non-magnetic material that physically connects the magnetic attraction core 50 and the sliding core 60 which are formed separately from each other. Therefore, no gap is formed between the magnetic attraction core 50 and the core portion 61. Therefore, it is possible to further suppress the magnetic flux from flowing directly between the core portion 61 and the magnetic attraction core 50. Therefore, the magnetic force indicated by the thick arrow in FIG. 8 is guided from the first magnetic flux transfer portion 65 to the plunger 30 side, and the magnetic efficiency is increased, and the slidability of the plunger 30 can be improved.

The solenoid 100d according to the fifth embodiment described above has the same effect as the solenoid 100c according to the fourth embodiment. In addition, since the magnetic flux passage suppressing portion 70b is formed of a non-magnetic material disposed without a gap between the magnetic attraction core 50 and the core portion 61, it is possible to suppress the magnetic flux from flowing directly between the magnetic attraction core 50 and the core portion 61 are directly connected to each other. The flow of the magnetic flux, and the magnetic force can be easily transmitted to the plunger 30. Therefore, the magnetic efficiency is increased, and the slidability of the plunger 30 can be improved.

### F. Sixth Embodiment

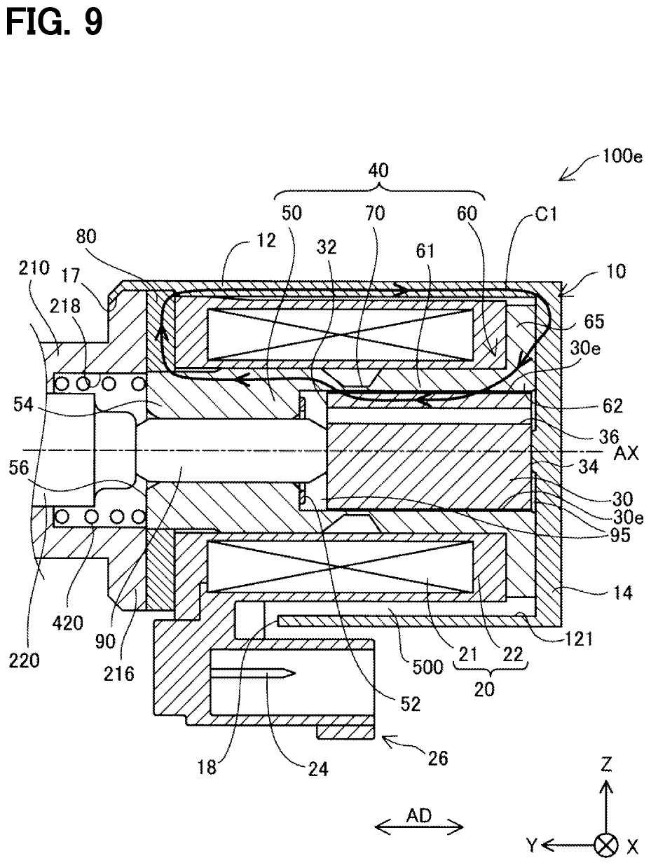

The solenoid 100e of the sixth embodiment shown in FIG. 9 includes a film portion 30e made of a non-magnetic material and covering a part of the outer peripheral surface of the plunger 30. The sixth embodiment differs from the solenoid 100 of the first embodiment in this point. The other configuration of the solenoid 100e according to the sixth embodiment other than the above is the same as the configuration of the solenoid 100 according to the first embodiment. Therefore, the same components are denoted by the same reference numerals, and description thereof will be omitted.

In the solenoid 100e of the sixth embodiment, a plating process on the outer peripheral surface of the plunger 30 is omitted, and the outer peripheral surface is covered with the film portion 30e. The film portion 30e is made of a Teflon sheet (Teflon is a registered trademark), and is wound around the surface of the plunger 30. In addition, it is not limited to Teflon and may be formed of any other non-magnetic material. Further, the film portion 30e of the present embodiment covers the plunger 30 over the entire length of the plunger 30 in the axial direction AD on the outer peripheral surface, that is, the radially outer surface of the plunger 30. The film portion 30e is not limited to the entire length of the plunger 30 in the axial direction AD, and may cover a part of the outer peripheral surface of the plunger 30 including the sliding portion of the plunger 30. The film portion 30e may cover the inner wall surface of the stator core 40 instead of the outer peripheral surface of the plunger 30, or may cover both the outer peripheral surface of the plunger 30 and the inner wall surface of the stator core 40. The film portion 30e may cover a part of the inner wall surface of the stator core 40 in the same manner as covering a part of the outer peripheral surface of the plunger 30.

The solenoid 100e according to the sixth embodiment described above has the same effect as the solenoid 100 according to the first embodiment. In addition, the film portion 30e is formed of a non-magnetic material, and covers at least a part of the outer peripheral surface of the plunger 30, or at least a part of the inner wall surface of the stator core 40, or covers both of a part of the outer peripheral surface of the plunger 30 and a part of the inner wall surface of the stator core 40. Therefore, the plating process on the outer peripheral surface of the plunger 30 can be omitted, and deterioration of the slidability due to the omission of the plating process can be suppressed.

### G. Other Embodiments

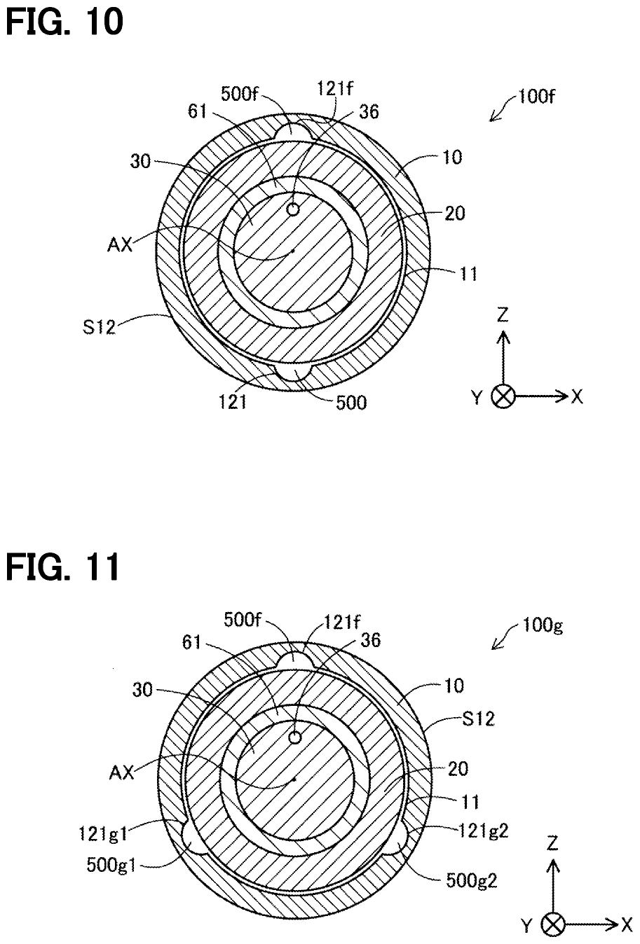

(1) In the second embodiment, the second breathing groove 122 is formed on the outer peripheral surface of the coil 20, but the present disclosure is not limited to this configuration. The second breathing groove may be formed on the inner peripheral surface 11 of the yoke 10. For example, in a solenoid 100f shown in FIG. 10, a second breathing groove 121f is formed on the inner peripheral surface 11 of the yoke 10 at a position shifted by 180 degrees with respect to the first breathing groove 121 with respect to the center axis AX. In such a configuration, the space formed between the second breathing groove 121f and the outer peripheral surface of the coil 20 functions as the second breathing passage 500f, like the breathing passage 500. The above configuration also has the same effect as the second embodiment.

(2) In each embodiment, the number of breathing grooves formed on the yoke 10 along the axial direction AD is only one, but may be any number. For example, there may be two as in the configuration shown in FIG. 10 described above. Further, in a solenoid 100g shown in FIG. 11, three breathing grooves 121f, 121g1, and 121g2 may be formed. In such a configuration, these three breathing grooves 121f, 121g1, and 121g2 are arranged to be shifted from each other by 120 degrees in the circumferential direction. In such a configuration, one or two of the three breathing grooves 121f, 121g1, and 121g2 correspond to the first breathing groove, and the other breathing grooves correspond to the second breathing groove. These three breathing grooves 121f, 121g1, and 121g2 may be arranged so as to be shifted from each other by different angles in the circumferential direction. In addition, not only two or three but also four or more arbitrary number of breathing grooves along the axial direction AD may be formed on the yoke 10.

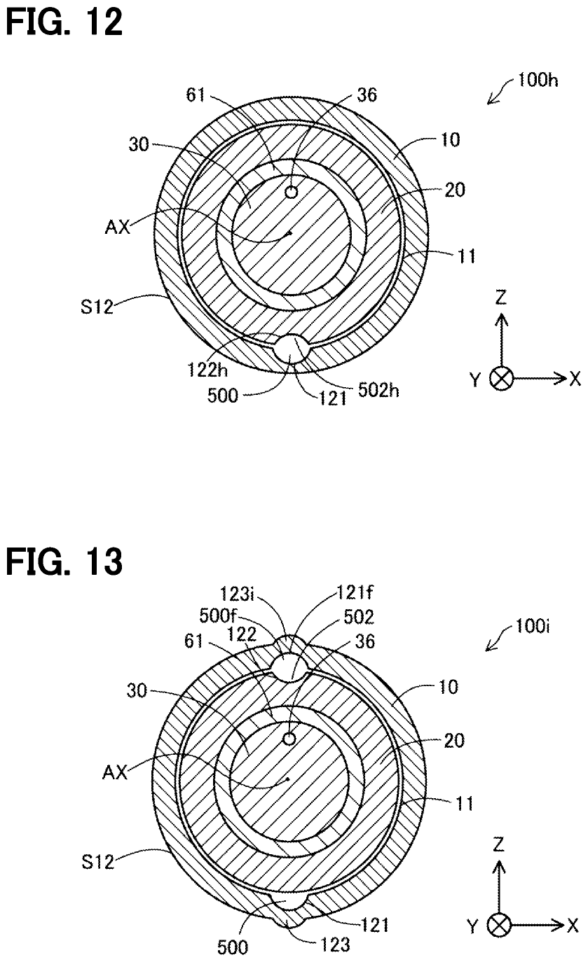

(3) In the second embodiment, the first breathing groove 121 and the second breathing groove 122 are formed at positions shifted from each other by 180 degrees with respect to the center axis AX. In the present embodiment, the first breathing groove 121 and the second breathing groove may be formed at an arbitrary position. For example, as in a solenoid 100h shown in FIG. 12, the first breathing groove 121 and the second breathing groove 122h may be arranged at the same position in the circumferential direction so that the two grooves overlap each other.

(4) The configurations of the first breathing groove, the second breathing groove, and the protrusion in each of the above embodiments are merely examples, and can be variously changed. For example, in the solenoid 100i shown in FIG. 13, the breathing grooves 121 and 121f are formed on the inner peripheral surface of the yoke 10, and the protrusions 123 and 123i are formed at positions corresponding to the breathing grooves 121 and 121f, respectively. The second breathing groove 122 is formed on the outer circumferential surface of the coil 20 so as to overlap with the breathing groove 121f at the same position in the circumferential direction. In such a configuration, for example, one of the two breathing grooves 121 and 121f may correspond to the first breathing groove, and the other may correspond to the second breathing groove. Further, for example, the first breathing groove, the second breathing groove, and the protrusion may be respectively formed at arbitrary positions, and any number of the first breathing groove, the second breathing groove, and the protrusion may be formed.

The present disclosure should not be limited to the embodiments described above, and various other embodiments may be implemented without departing from the scope of the present disclosure. For example, the technical features in each embodiment corresponding to the technical features in the form described in the summary may be used to solve some or all of the above-described problems, or to provide one of the above-described effects. In order to achieve a part or all, replacement or combination can be appropriately performed. Also, if the technical features are not described as essential in the present specification, they can be deleted as appropriate.

In the assumable example, a solenoid has a coil that generates a magnetic force when energized, a stator core provided inside the coil, and a plunger that slides inside the stator core. In the solenoid described in Patent Document 1 (Japanese Patent No. 4569371), a breathing passage communicating a plunger tip chamber with an outside of a linear solenoid is provided. This configuration suppresses deterioration of the slidability of the plunger due to a change in an internal pressure of the plunger tip chamber due to an axial movement of the plunger.

In the solenoid described in Patent Document 1, the breathing passage is a radial gap between the coil and the yoke, and is formed over an entire circumference. Therefore, an outer diameter of the yoke tends to be large, and there is a problem that the solenoid becomes large. Therefore, a technique capable of suppressing an increase in the size of the solenoid while securing the breathing passage is desired.

The present disclosure can be realized as the following embodiments.

According to one embodiment of the present disclosure, a solenoid 100 to 100i is provided. The solenoid includes a coil 20 that generates a magnetic force when energized, a yoke 10 including a side surface portion 12 along an axial direction AD and a bottom portion 14 formed along a direction intersecting the axial direction, and the yoke being configured to accommodate the coil, a columnar plunger 30 configured to slide in the axial direction. A stator core 40 includes a magnetic attraction core 50 arranged in the axial direction to face a distal end surface 32 of the plunger and configured to attract magnetically the plunger by a magnetic force generated by the coil, a sliding core 60 having a cylindrical core portion 61 that is disposed inside the coil in a radial direction perpendicular to the axial direction and accommodates the plunger, and a first magnetic flux transfer portion 65 that is formed from a core end portion 62, which is an end of the core portion in the axial direction and faces the bottom portion, toward an outside in the radial direction, and is configured to transfer the magnetic flux between the yoke and the core portion, a magnetic flux passage suppressing portion 70 configured to suppress passage of magnetic flux between the sliding core and the magnetic attraction core. A second magnetic flux transfer portion 80 that is disposed radially outside a magnetic attraction core end 54, which is an end in the axial direction of the magnetic attraction core and is opposite to a side facing the distal end surface, and is configured to transfer the magnetic flux between the magnetic attraction core and the side surface portion. A first breathing groove 121 extending in the axial direction in communication with the outside is formed on an inner peripheral surface 11 of the yoke.

According to the solenoid of the present disclosure, since the first breathing groove communicating with the outside and extending in the axial direction is formed on the inner peripheral surface of the yoke, the gap formed between the first breathing groove and the outer peripheral surface of the coil is can be used as a breathing passage. Therefore, the size of the gap (the length in the radial direction) is smaller and an outer diameter of the yoke can be reduced in comparison with a configuration in which only the gap formed over the entire circumference between the outer peripheral surface of the coil and the inner peripheral surface of the yoke is used as a breathing passage. As described above, according to the solenoid of the present embodiment, it is possible to suppress an increase in size of the solenoid while securing the breathing passage.

1. A solenoid, comprising:
a coil configured to generate a magnetic force when energized;
a yoke including a side surface portion along an axial direction and a bottom portion formed along a direction intersecting the axial direction, and the yoke being configured to accommodate the coil;
a columnar plunger configured to slide in the axial direction;
a stator core including
a magnetic attraction core arranged in the axial direction to face a distal end surface of the plunger and configured to attract magnetically the plunger by a magnetic force generated by the coil,
a sliding core having a cylindrical core portion that is disposed inside the coil in a radial direction perpendicular to the axial direction and accommodates the plunger, and a first magnetic flux transfer portion that is formed from a core end portion, which is an end of the core portion in the axial direction and faces the bottom portion, toward an outside in the radial direction, and is configured to transfer the magnetic flux between the yoke and the core portion, and
a magnetic flux passage suppressing portion configured to suppress passage of magnetic flux between the sliding core and the magnetic attraction core; and
a second magnetic flux transfer portion that is disposed radially outside a magnetic attraction core end, which is an end in the axial direction of the magnetic attraction core and is opposite to a side facing the distal end surface, and is configured to transfer the magnetic flux between the magnetic attraction core and the side surface portion, wherein
a first breathing groove extending in the axial direction in communication with the outside is formed on an inner peripheral surface of the yoke.

2. The solenoid according to claim 1, wherein
a second breathing groove that extends in the axial direction and a circumferential groove that extends in a circumferential direction and communicates the first breathing groove and the second breathing groove are formed on at least one of the inner peripheral surface of the yoke and the outer peripheral surface of the coil.

3. The solenoid according to claim 1, wherein
a protrusion extending in the axial direction and projecting in the outer diameter direction is formed at a position corresponding to the first breathing groove on the outer peripheral surface of the yoke.

4. The solenoid according to claim 1, wherein
The magnetic flux passage suppressing portion includes a non-magnetic connecting portion that physically connects the magnetic attraction core and the sliding core which are formed separately from each other.

5. The solenoid according to claim 1, wherein
a film portion formed of a non-magnetic material covers at least a part of the outer peripheral surface of the plunger, or at least a part of the inner surface of the stator core, or covers both of a part of the outer peripheral surface of the plunger and a part of the inner wall surface of the stator core.
